(19) United States
(12) Patent Application Publication
(10) Pub. No.: US 2010/0129776 A1
(43) Pub. Date: May 27, 2010

(54) ALGINATE IMPRESSION METHOD FOR DENTAL TREATMENT

(76) Inventor: Jongwook LEE, Rancho Palos Verdes, CA (US)

Correspondence Address: PARK LAW FIRM, 3255 WILSHIRE BLVD, SUITE 1110, LOS ANGELES, CA, 90010, US

(21) Appl. No.: 12/324,360

(22) Filed: Nov. 26, 2008

(51) Int. Cl. A61C 9/00

(52) U.S. Cl. 433/215; 433/6

(57) ABSTRACT

An alginate impression method for dental treatment is provided. The method comprises steps of: providing alginate in a squeezable pouch; providing water in a syringe; injecting the water into the squeezable pouch; closing the squeezable pouch; kneading the squeezable pouch so as to mix the alginate and the water inside; and squeezing out the mixed alginate and water from the opening of the pouch onto a mold so as to make an impression. The syringe may comprise a tube portion having a first opening and a second opening and a plunger configured to be fit into the second opening of the tube portion for piston pumping movement. The first opening may fit air-tightly with the opening of the squeezable pouch so as to inject water into the squeezable pouch.

### BACKGROUND OF THE INVENTION

The present invention relates to an alginate impression method. More particularly, this invention relates to an alginate impression method, which enables to conserve time, labor, material, and maintenance.

Preparing a mold is usually messy job in the community. A rubber bowl and a mixing spatula are needed to mix the alginate, the molding material in a dental clinic, with water as shown in FIG. 1.

One cannot avoid wasting material and cleaning the bowl and spatula after molding in the traditional method to mix alginate with water using the bowl and the spatula. Usually, it takes a lot of water clean the bowl and the spatula after the work.

With the traditional method to mix the alginate with water in the bowl using spatula, it takes more time and effort.

Accordingly, a need for an alginate impression method has been present for a long time in the community considering its extensive usage. This invention is directed to solve these problems and satisfy the long-felt need.

### SUMMARY OF THE INVENTION

The present invention contrives to solve the disadvantages of the prior art.

An objective of the invention is to provide an alginate impression method for dental treatment.

Another object of the invention is to provide an alginate impression method, which enables clean mixing process.

Still another object of the invention is to provide an alginate impression method, which enables conserving molding material.

An aspect of the invention provides an alginate impression method for dental treatment.

The method comprises steps of: providing alginate of a first predetermined amount in a squeezable pouch, wherein the squeezable pouch comprises container portion, an opening, and a lid; providing water of a second predetermined amount in a syringe; injecting the water into the squeezable pouch; closing the squeezable pouch with the lid; kneading the squeezable pouch so as to mix the alginate and the water inside; and squeezing out the mixed alginate and water from the opening of the pouch onto a mold so as to make an impression.

The method may further comprise, prior to the step of providing alginate, a step of measuring the first predetermined amount of alginate.

The method may further comprise, prior to the step of providing water, a step of measuring the second predetermined amount of water.

The syringe may comprise a tube portion having a first opening and a second opening and a plunger configured to be fit into the second opening of the tube portion for piston pumping movement.

The first opening may be configured to fit air-tightly with the opening of the squeezable pouch so as to inject water into the squeezable pouch.

The opening of the squeezable pouch may comprise a plurality of female threads inside the opening, and the first opening of the syringe may comprise a plurality of male threads, around the first opening, fitting with the female threads in the opening of the squeezable pouch. Also, the lid of the pouch may comprise a plurality of male threads fitting with the female threads in the opening of the squeezable pouch.

The opening of the squeezable pouch may comprise a plurality of male threads around the opening, and the first opening of the syringe may comprise a plurality of female threads, inside the first opening, fitting with the male threads in the opening of the squeezable pouch. Also, the lid of the pouch may comprise a plurality of female threads fitting with the male threads in the opening of the squeezable pouch.

The step of providing alginate may comprise a step of injecting alginate into the squeezable pouch as inflating the squeezable pouch with the injected alginate.

The step of providing water may comprise a step of injecting water into the squeezable pouch as inflating the squeezable pouch with the injected water.

The method may further comprise, prior to the step of squeezing out, a step of opening the lid out of the squeezable pouch.

The method may further comprise, prior to the step of closing, a step of deflating the squeezable pouch by letting out air from inside.

The step of kneading may comprise a step of shaking the squeezable pouch.

The method may further comprise a step of discarding the squeezable pouch after the step of squeezing out.

Another aspect of the invention provides an alginate pouch package for dental impression.

The package comprises: a squeezable pouch comprising a container portion, an opening, and a lid; and a predetermined amount of alginate powder disposed in the squeezable pouch. The lid seals the squeezable pouch air-tightly, and wherein the squeezable pouch is substantially deflated.

The opening of the squeezable pouch may comprise a plurality of male threads around the opening. The lid may be configured to be easily removed. The syringe may comprise a tube portion having a first opening and a second opening and a plunger configured to be fit into the second opening of the tube portion for piston pumping movement, and wherein the first opening is configured to fit air-tightly with the opening of the squeezable pouch so as to inject water into the squeezable pouch.

Still another aspect of the invention provides an alginate impression method for dental treatment using the alginate pouch package in the above.

The method comprising steps of: providing water of a second predetermined amount in a syringe; injecting the water into the squeezable pouch; closing the squeezable pouch with the lid; kneading the squeezable pouch so as to mix the alginate and the water inside; squeezing out the mixed alginate and water from the opening of the pouch onto a mold so as to make an impression; and discarding the squeezable pouch.

The advantages of the present invention are: (1) the alginate impression method makes alginate impression easier and cleaner; and (2) the material for the alginate impression can save a lot using the alginate impression method.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing mixing alginate with water in a bowl with a spatula according to a prior art;

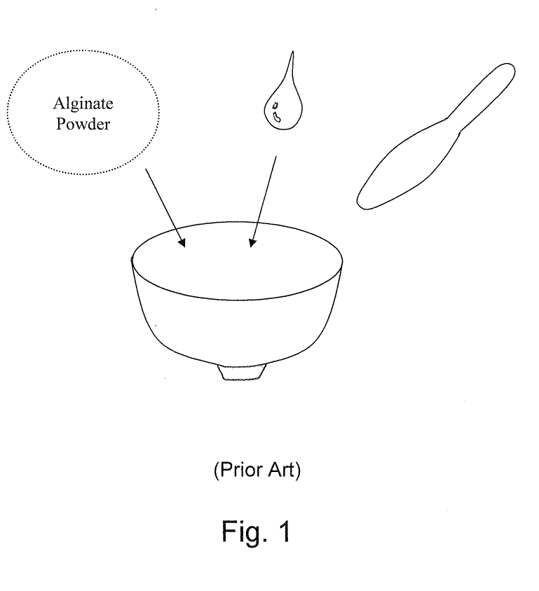

FIG. 2 is a flowchart showing an alginate impression method according to an embodiment of the invention;

FIG. 3 is a perspective view of a squeezable pouch according to an embodiment of the invention;

FIG. 4 is a perspective view of a syringe according to an embodiment of the invention; and

FIG. 5 is a flowchart showing an alginate impression method according to another embodiment of the invention.

### DETAILED DESCRIPTION EMBODIMENTS OF THE INVENTION

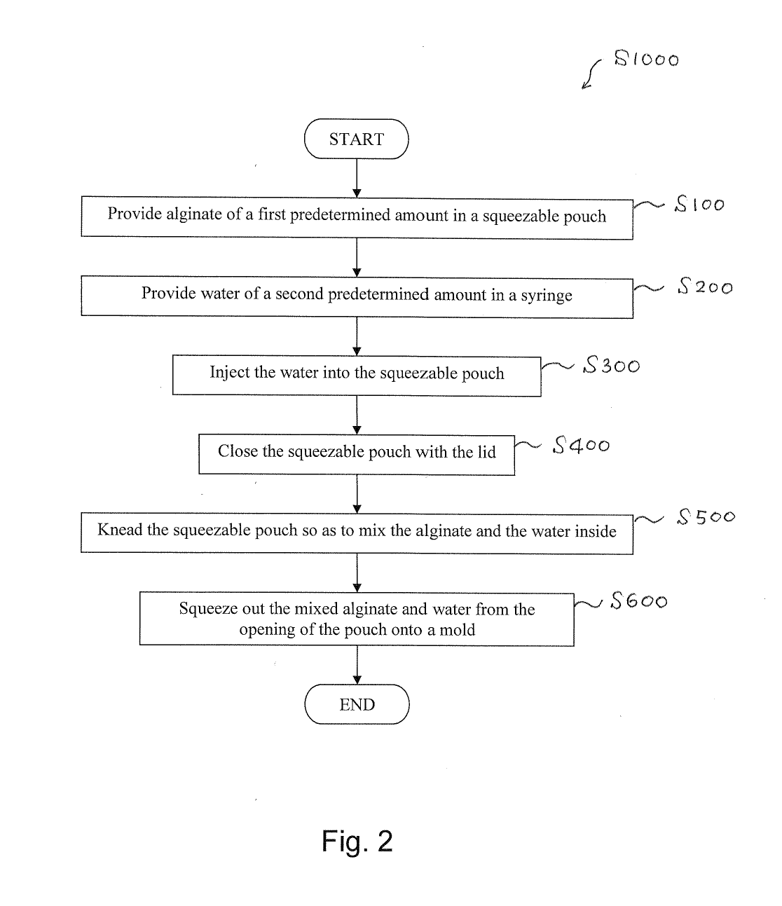

FIGS. 2-5 show an alginate impression method S1000 according to embodiments of the present invention.

An aspect of the invention provides an alginate impression method for dental treatment.

The method S1000 comprises steps of: providing alginate of a first predetermined amount in a squeezable pouch 100, wherein the squeezable pouch comprises container portion 110, an opening 120, and a lid 130 (S100); providing water of a second predetermined amount in a syringe 200 (S200); injecting the water into the squeezable pouch 100 (S300); closing the squeezable pouch 100 with the lid 130 (S400); kneading the squeezable pouch 100 so as to mix the alginate and the water inside (S500); and squeezing out the mixed alginate and water from the opening 120 of the squeezable pouch 100 onto a mold (not shown) so as to make an impression (S600).

The method S1000 may further comprise, prior to the step S100 of providing alginate, a step of measuring the first predetermined amount of alginate.

The method S1000 may further comprise, prior to the step S200 of providing water, a step of measuring the second predetermined amount of water.

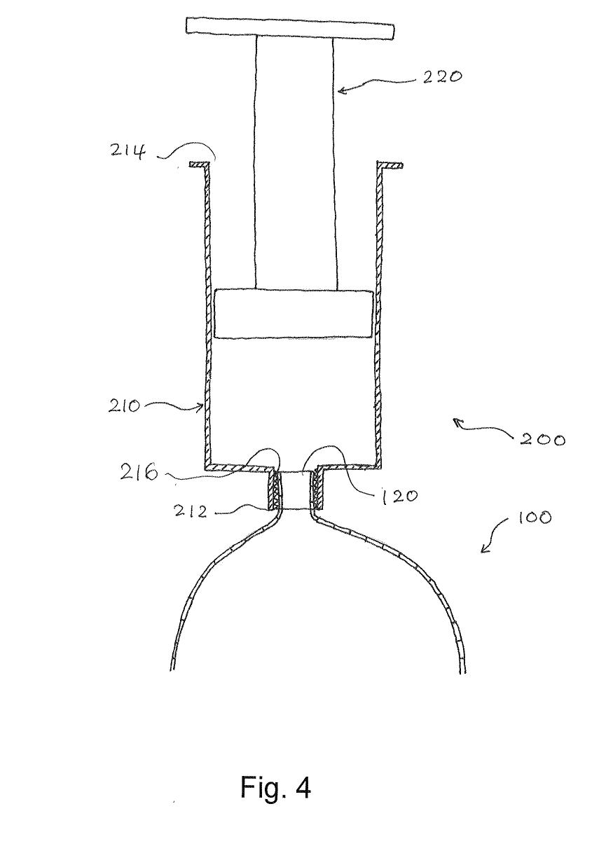

The syringe 200 may comprise a tube portion 210 having a first opening 212 and a second opening 214 and a plunger 220 configured to be fit into the second opening 214 of the tube portion 210 for piston pumping movement as shown in FIG. 4.

The first opening 212 may be configured to fit air-tightly with the opening 120 of the squeezable pouch 100 so as to inject water into the squeezable pouch 100 as shown in FIG. 4.

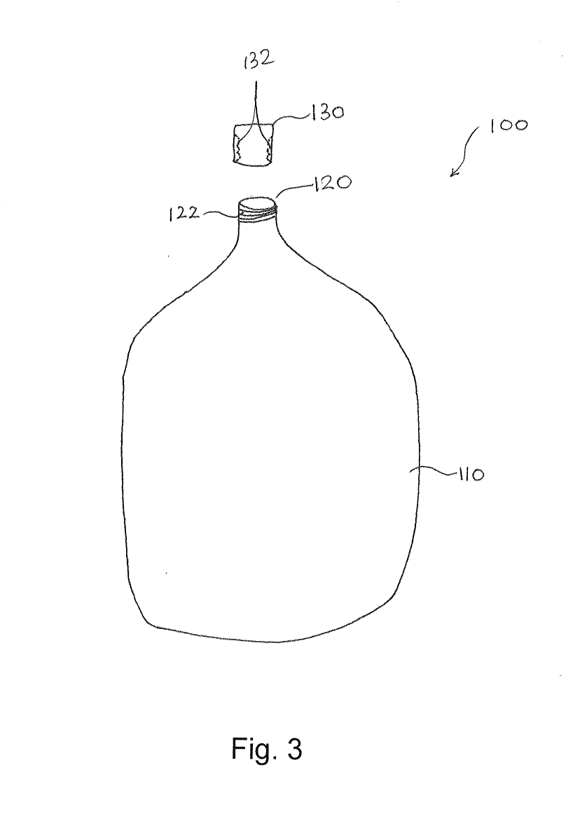

The opening 120 of the squeezable pouch 100 may comprise a plurality of female threads inside the opening 120, and the first opening 212 of the syringe 200 may comprise a plurality of male threads, around the first opening 212, fitting with the female threads in the opening 120 of the squeezable pouch 100. Also, the lid 130 of the pouch 100 may comprise a plurality of male threads fitting with the female threads in the opening 120 of the squeezable pouch 100. The female and male threads in this embodiment are not shown, but can be easily imagine by reversing the female threads and the male threads in FIGS. 3 and 4 as below.

That is, as shown in FIGS. 3 and 4, alternatively, the opening 120 of the squeezable pouch 100 may comprise a plurality of male threads 122 around the opening 120, and the first opening 212 of the syringe 200 may comprise a plurality of female threads 216, inside the first opening 212, fitting with the male threads 122 in the opening 120 of the squeezable pouch 100. Also, the lid 130 of the squeezable pouch 100 may comprise a plurality of female threads 132 fitting with the male threads 122 in the opening 120 of the squeezable pouch 100.

The step S100 of providing alginate may comprise a step of injecting alginate into the squeezable pouch 100 as inflating the squeezable pouch 100 with the injected alginate. That is, initially, the squeezable pouch 100 may be already deflated. Since the syringe 200 is air-tightly fitted with the squeezable pouch 100, otherwise the squeezable pouch 100 may be too inflated all the way to be injected with water further.

The step S200 of providing water may comprise a step of injecting water into the squeezable pouch 100 as inflating the squeezable pouch 100 with the injected water.

The method S1000 may further comprise, prior to the step S600 of squeezing out, a step of opening the lid 130 out of the squeezable pouch 100.

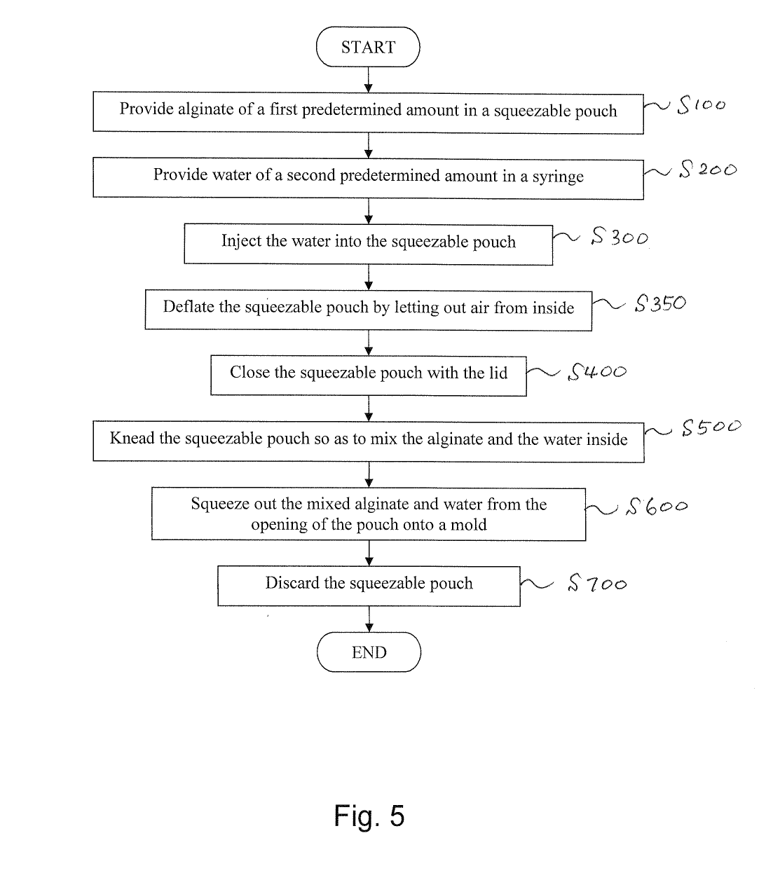

The method S1000 may further comprise, prior to the step S400 of closing, a step S350 of deflating the squeezable pouch 100 by letting out air from inside as shown in FIG. 5.

The step S500 of kneading may comprise a step of shaking the squeezable pouch 100. Since the alginate and water are sealed inside the pouch 100, a user can apply a plurality of movement to it. There will no spill out or overflow in the process of mixing of the alginate with water.

The method S1000 may further comprise a step of discarding the squeezable pouch after the step of squeezing out S700. After using all the mixed alginate inside, the whole squeezable pouch 100 may be simply discarded. One does not have to worry about cleaning the bowl or the spatula as in the prior arts.

Another aspect of the invention provides an alginate pouch package for dental impression.

The package comprises: a squeezable pouch 100 comprising a container portion 110, an opening 120, and a lid 130; and a predetermined amount of alginate powder disposed in the squeezable pouch 100. The lid 130 seals the squeezable pouch 100 air-tightly, and the squeezable pouch 100 may be substantially deflated for storing or transporting.

The opening 120 of the squeezable pouch 100 may comprise a plurality of male threads 122 around the opening 120. The lid 130 may be configured to be easily removed or reinstalled. The syringe 200 may comprise a tube portion 210 having a first opening 212 and a second opening 214 and a plunger 220 configured to be fit into the second opening 214 of the tube portion 210 for piston pumping movement, and the first opening 212 may be configured to fit air-tightly with the opening 120 of the squeezable pouch 100 so as to inject water into the squeezable pouch 100.

Still another aspect of the invention provides an alginate impression method for dental treatment using the alginate pouch package in the above.

As in the embodiment in the above, the method comprising steps of: providing water of a second predetermined amount in a syringe; injecting the water into the squeezable pouch; closing the squeezable pouch with the lid; kneading the squeezable pouch so as to mix the alginate and the water inside; squeezing out the mixed alginate and water from the opening of the pouch onto a mold so as to make an impression; and discarding the squeezable pouch.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An alginate impression method for dental treatment, the method comprising steps of:
providing alginate of a first predetermined amount in a squeezable pouch, wherein the squeezable pouch comprises a container portion, an opening, and a lid;
providing water of a second predetermined amount in a syringe;
injecting the water into the squeezable pouch;
closing the squeezable pouch with the lid;
kneading the squeezable pouch so as to mix the alginate and the water inside; and
squeezing out the mixed alginate and water from the opening of the pouch onto a mold so as to make an impression.

2. The method of claim 1, further comprising, prior to the step of providing alginate, a step of measuring the first predetermined amount of alginate.

3. The method of claim 1, further comprising, prior to the step of providing water, a step of measuring the second predetermined amount of water.

4. The method of claim 1, wherein the syringe comprises a tube portion having a first opening and a second opening and a plunger configured to be fit into the second opening of the tube portion for piston pumping movement.

5. The method claim 4, wherein the first opening is configured to fit air-tightly with the opening of the squeezable pouch so as to inject water into the squeezable pouch.

6. The method of claim 5, wherein the opening of the squeezable pouch comprises a plurality of female threads inside the opening, wherein the first opening of the syringe comprises a plurality of male threads, around the first opening, fitting with the female threads in the opening of the squeezable pouch, and wherein the lid of the pouch comprises a plurality of male threads fitting with the female threads in the opening of the squeezable pouch.

7. The method of claim 5, wherein the opening of the squeezable pouch comprises a plurality of male threads around the opening, wherein the first opening of the syringe comprises a plurality of female threads, inside the first opening, fitting with the male threads in the opening of the squeezable pouch, and wherein the lid of the pouch comprises a plurality of female threads fitting with the male threads in the opening of the squeezable pouch.

8. The method of claim 5, wherein the step of providing alginate comprises a step of injecting alginate into the squeezable pouch as inflating the squeezable pouch with the injected alginate.

9. The method of claim 5, wherein the step of providing water comprises a step of injecting water into the squeezable pouch as inflating the squeezable pouch with the injected water.

10. The method of claim 1, further comprising, prior to the step of squeezing out, a step of opening the lid out of the squeezable pouch.

11. The method of claim 1, further comprising, prior to the step of closing, a step of deflating the squeezable pouch by letting out air from inside.

12. The method of claim 1, wherein the step of kneading comprises a step of shaking the squeezable pouch.

13. The method of claim 1, further comprising a step of discarding the squeezable pouch after the step of squeezing out.

14. An alginate pouch package for dental impression, comprising:
a squeezable pouch comprising a container portion, an opening, and a lid; and
a predetermined amount of alginate powder disposed in the squeezable pouch,
wherein the lid seals the squeezable pouch air-tightly, and wherein the squeezable pouch is substantially deflated.

15. The package of claim 14, wherein the opening of the squeezable pouch comprises a plurality of male threads around the opening.

16. The package of claim 15, wherein the lid is configured to be easily removed.

17. The package of claim 16, further comprising a syringe, wherein the syringe comprises a tube portion having a first opening and a second opening and a plunger configured to be fit into the second opening of the tube portion for piston pumping movement, and wherein the first opening is configured to fit air-tightly with the opening of the squeezable pouch so as to inject water into the squeezable pouch.

18. An alginate impression method for dental treatment using the alginate pouch package of claim 14, the method comprising steps of:
providing water of a second predetermined amount in a syringe;
injecting the water into the squeezable pouch;
closing the squeezable pouch with the lid;
kneading the squeezable pouch so as to mix the alginate and the water inside;
squeezing out the mixed alginate and water from the opening of the pouch onto a mold so as to make an impression; and
discarding the squeezable pouch.
